(19) United States
(12) Patent Application Publication
(10) Pub. No.: US 2010/0244344 A1
(43) Pub. Date: Sep. 30, 2010

(54) COMPACT TOOLS WITH SUCTION CUPS FOR HANDLING ROBOT

(75) Inventor: Didier Mougin, Octeville-sur-mer (FR)

Correspondence Address: SUGHRUE MION, PLLC, 2100 PENNSYLVANIA AVENUE, N.W., SUITE 800, WASHINGTON, DC, 20037, US

(73) Assignee: SIDEL PARTICIPATIONS, Octeville-sur-mer (FR)

(21) Appl. No.: 12/746,137

(22) PCT Filed: Dec. 1, 2008
(86) PCT No.: PCT/FR2008/052170

§ 371 Date: Jun. 3, 2010

(30) Foreign Application Priority Data
Dec. 4, 2007 (FR) 07 08452

(51) Int. Cl. B25B 11/00

(52) U.S. Cl. 269/21

(57) ABSTRACT

The invention relates to a tool that comprises a body (1) in the form of a compact unit made of an appropriate material of the thermoplastic resin material type. The body (1) is adapted for placing the vacuum generator as close as possible to the suction cup (2). It comprises: on the one hand, a bore for housing the vacuum generator in the form of a cartridge (3), wherein said bore defines the vacuum chamber (44) and communicates, on the side corresponding to the inlet of said cartridge (3), with the pressurised air supply, and on the other side, i.e. the side corresponding to the outlet of said cartridge, with an expansion chamber (39) in the form of a silencer; and on the other hand, a very short inner circuit between said vacuum chamber (44) and the suction cup (2), that comprises one or more cavities and/or openings.

### FIELD OF THE INVENTION

The present invention relates to holding tooling of the suction cup(s) type associated with a robot for manipulating products with a view to boxing them for example.

### DESCRIPTION OF THE PRIOR ART

Present-day tooling used on certain product boxing machines consists of a support over which several suction cups are generally distributed and this support is fixed to the end of the arm of a manipulating robot.

The suction cups are connected by flexible pipes to a single vacuum generator situated on the supporting structure of the boxing machine and sometimes on the robot.

Because the tooling is very heavy in relation to the mass of the products that are to be manipulated, such as sachets or pouches for example, present-day robots are over-engineered in relation to the payload that they are to handle.

More “lightweight” robots do exist and these are also generally very high speed but cannot be exploited to the best of their capabilities because, firstly, of the weight of the tooling used and, secondly, of their acceleration and speed of movement capabilities.

The problem is that this speed of movement generates accelerations that soon become problematic, accelerations which are somewhat incompatible with the holding system whereby suction cups are used to hold the products.

The effectiveness of the grip on the products is exclusively dependent on the effectiveness of the suction cups and this effectiveness is notably dependent on the suction and level of leakage prevalent in each of these.

When one of the suction cups lets go of its product, the suction at the other suction cups becomes insufficient overall, and the entire batch of products becomes dispersed.

The suction cups, which are situated some distance away from the vacuum generator or generators, are supplied via flexible pipes of varying length with pressure drops. In addition, the pipes and couplings are subject to wear upon contact with the various arms of the robot and particularly at the articulations and, as a result, become damaged and may give rise to incidents associated with loss of suction.

Suction cup devices, such as those described in document U.S. Pat. No. 3,716,307, do exist, which are designed to allow the connection between the product being manipulated and its suction cup to be maintained and safeguarded in the event of a loss of suction.

This kind of device is used for maneuvering sheets of glass, for example, but is not specially designed to be fitted to a robot which operates at a high rate, and to act as a gripper head for packages.

The tooling according to the invention simplifies the suction cup supply circuits and eliminates a good proportion of the risks of damage. This simplification of the circuits also makes it possible considerably to reduce the pressure drops between the vacuum generator or generators and the suction cup or cups.

The tooling according to the invention benefits from a sharp reduction in weight and makes it possible to use a robot that is lightweight, and therefore very high speed, for the high-speed handling of products of moderate size and weight, weighing a few tens or hundreds of grams.

Using the tooling according to the invention, the robot manipulates a total load, comprising said tooling and the products that are to be boxed, which is relatively low, not exceeding 5 to 6 kg.

This tooling improves boxing rates, for example and, above all, reduces if not completely eliminates the risks of incidents.

### SUMMARY OF THE INVENTION

In order to improve the effectiveness with which the products, which are relatively lightweight, are held, the tooling according to the invention is associated with a robot of the high-speed type and consists of a body in the form of a compact block made of an appropriate lightweight material, which compact block comprises:
a bore to house the vacuum generator which is in the form of a cartridge; which bore constitutes the vacuum chamber and extends, fluidtightly by way of said cartridge, between the compressed air inlet chamber into which the inlet of said cartridge opens and the expansion chamber which acts as a silencer on the outlet side of said cartridge from which the air escapes,
an internal circuit which connects said vacuum chamber and the suction cup or cups, said connection consisting of orifice(s) and/or cavity(cavities),
an elongate part in which the cartridge is housed, and
at least one lateral protrusion contiguous with the vacuum chamber, which protrusion accommodates the suction cup the axis of which is parallel to that of the cartridge.

According to a first embodiment of the invention, the tooling is in the form of a body in the form of a block which is designed to allow it to be installed on a mount which comprises several bodies, which bodies are arranged vertically, in pairs, assembled with said mount at the protrusion that carries the suction cup and that lies under said mount, which mount is covered with a perforated cap which forms an expansion chamber, which cap encloses a material of the foam type which acts as an acoustic insulator.

The tooling according to the invention may also on the whole be in even more compact form.

Thus, according to another embodiment, the tooling is in the form of a one-piece body made of a material of the resin kind, or composite or thermoplastic, which body is made up of strata fashioned beforehand and assembled by bonding and intrinsically comprising:
vacuum chambers and circuits connecting these chambers and the suction cups which are grafted onto said body,
an overall supply chamber for supplying all the various cartridges with compressed air, and
an expansion chamber which is common to said cartridges, which cartridges are arranged side by side and mutually parallel, and said suction cups are grafted under said body, perpendicular to the cartridges.

This design, in the form of strata, means that a plurality of models of the tooling in question can be produced in a simple way in order to be able to offer a variable number of suction cups and cartridges, while at the same time also affording the option of varying the number of suction cups supplied from a single cartridge.

According to a preferred embodiment of the invention, the block comprises four cartridges which are housed in bores the axes of which are mutually parallel, situated in the same plane, and the suction cups are four in number also, each supplied independently of the others by one cartridge, which suction cups are centered in two parallel planes which are perpendicular to said plane of the axes of said cartridges, each suction cup plane being situated, for example, in the mid-plane of the cartridges which respectively supply said suction cups.

Still in this preferred embodiment of the invention, the bores accommodating the various cartridges open, at one side, into a common compressed air inlet chamber which compressed air supplies the upstream part of the cartridges and, on the other side, that is to say on the exhaust side, are each closed off by a plug which locks the corresponding cartridge in its bore, which plug has radial openings which openings open into a common expansion chamber lined with an appropriate material able to deaden the noise of the escaping compressed air leaving each cartridge.

### BRIEF DESCRIPTION OF THE DRAWINGS

However, the invention will be explained in even greater detail with the aid of the following description and of the appended drawings, given by way of indication and in which:

FIG. 1 shows, in the form of a functional diagram, simplified tooling consisting of an elementary block combining the suction cup and its vacuum generator, which generator is in the form of a cartridge;

FIG. 2 shows a cartridge commonly used for creating vacuum at the suction cups, which cartridge is depicted half in an external view and half in longitudinal section;

FIG. 3 shows, in perspective, one possible embodiment of compact tooling consisting of several elementary blocks to form a compact head which head is, for example, installed on a manipulator robot arm, not depicted;

FIG. 4 is a perspective view of another embodiment of tooling which is even more compact, according to the invention, and made for example of resin;

FIG. 5 is a head-on view of the tooling depicted in FIG. 4;

FIG. 6 is a vertical section of FIG. 5 on a vertical plane passing through the axis of a cartridge;

FIG. 7 depicts four part sections on 7-7 of FIG. 5 to show the various arrangements of the one-piece body that constitutes the tooling.

### DETAILED DESCRIPTION OF THE INVENTION

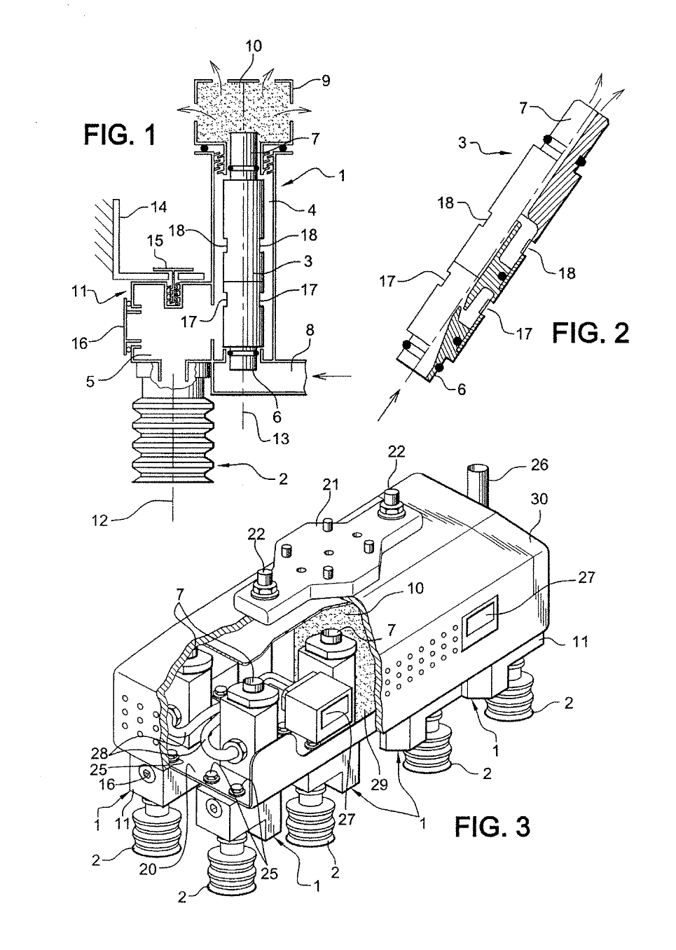

FIG. 1 depicts tooling that can be qualified as elementary tooling. This tooling comprises:
a body 1 which consists of a compact block of lightweight material, of the thermoplastic or resin type, which block is fashioned by machining and/or by molding and machining,
at least one suction cup 2 which is fixed to said body 1,
a vacuum generator which is in the form of a cartridge 3, and said body comprises bores which place said cartridge 3 and said suction cup 2 in communication.

These bores on the one hand constitute a vacuum chamber 4 containing the cartridge 3 and on the other hand constitute an ultra-short internal circuit in the form of an orifice or cavity 5 which connects said chamber 4 to said suction cup 2 directly.

The vacuum chamber 4 extends, in a fluidtight manner by means of the cartridge 3, between the inlet and the outlet of said cartridge 3, which inlet constitutes the mouth 6 and the outlet is in the form of a nozzle 7.

This mouth 6 communicates with the compressed air inlet chamber 8 and the nozzle 7 opens into an expansion chamber 9, which chamber 9 is in the form of a pierced cap lined with an absorbent material (10) of the foam type, acting as a silencer.

The cartridge 3 is housed in the elongate part of the body 1 and the suction cup 2 is fixed to a protrusion 11 which comprises the cavity 5, which protrusion is arranged on the side of this elongate part of said body 1; the axis 12 of said suction cup 2 and the axis 13 of the cartridge 3 are parallel.

This body 1, consisting of a block containing a cartridge 3 and provided with a suction cup 2, forms elementary tooling which, for example, may be fixed to the end of an arm 14 of a manipulator robot, at the protrusion 11, using screws 15.

The protrusion 11 also comprises a plug 16 which closes off the end of the cavity 5.

FIG. 2 provides greater detail of the cartridge 3 which supplies the suction cup 2. This cartridge, of the type that has two vacuum stages, is in the form of a cylinder between the mouth 6 and the nozzle 7 and this cylinder is provided with two pairs of orifices 17 and 18, each pair of orifices corresponding to one stage of vacuum.

This type of cartridge 3 can also supply two suction cups 2 and even more, as the case may require, arranged in a star configuration for example, through several protrusions all of which are connected to the vacuum chamber 4.

FIG. 3 shows one possible way of producing compact tooling which consists of a plurality of bodies 1, that is to say that each body comprises one suction cup 2 and this suction cup is supplied by one single cartridge 3.

The various bodies 1 are combined onto a mount 20 which may be fixed, by means of a mounting plate 21, on the arm of a robot, not depicted. This mounting plate 21 is situated above the level of the upper part of the bodies 1 and is connected to the mount 20 by means of supports 22 in the form of threaded shanks.

This mount 20 is in the form of a bent metal sheet and has perforations through which the upper elongate part of the bodies 1 can pass and to allow these to be assembled with said mount by means of screws 25 collaborating with the protrusions 11.

The compressed air inlet into each body 1 is situated under the mount 20 and these various inlets are joined together and supplied by a common inlet via the hose 26 which, for example, is situated at one of the ends of said mount 20.

The mount 20 may also serve to support instruments for monitoring the vacuum in the various suction cups 2. Two vacuostats 27 are depicted; these are each connected, by means of hoses 28, to the various vacuum chambers 4 of the bodies 1.

The upper part of the bodies 1 reveals the nozzle 7 of the corresponding cartridges 3, which nozzle 7 is situated in the expansion chamber 29, which chamber 29 is delimited by a cap 30 the role of which is identical to that of the cap of the chamber 9 discussed in FIG. 1.

This cap 30 is perforated and contains a foam material 10 which acts as an acoustic insulator, absorbing the noise of the various outlets 7 via which the compressed air that passes through the cartridges 3 escapes.

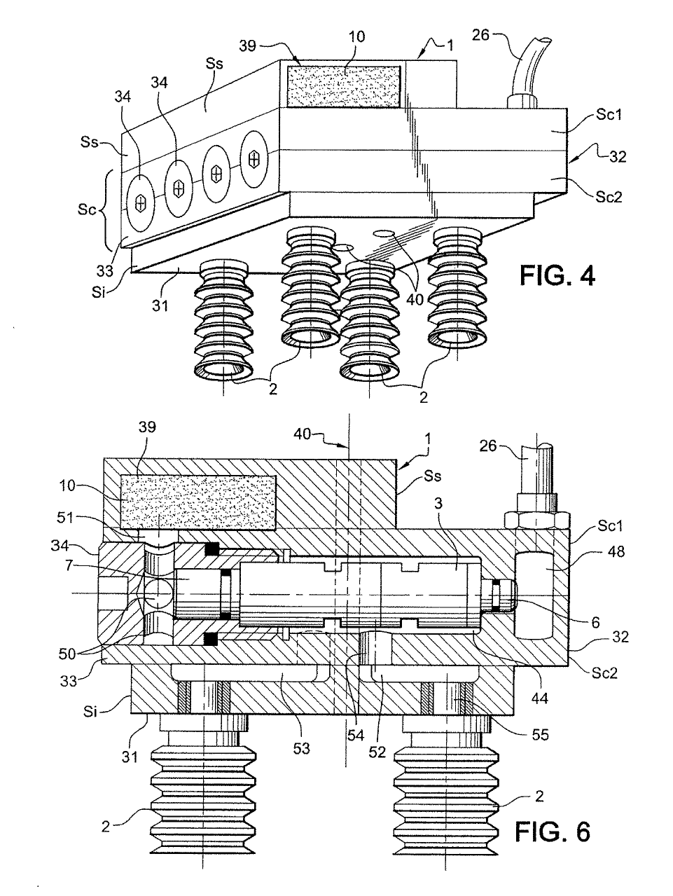

FIG. 4 shows another embodiment of particularly compact tooling which comprises several suction cups 2 and this tooling has the special feature of consisting of a one-piece body 1.

This body 1 is in the form of a block of lightweight material, of the resin, composite or thermoplastic kind, which is designed to combine all of the equipment needed for holding the products and for operating this equipment effectively, connecting the various parts together by means of circuits internal to said block, particularly ultra-short circuits.

The suction cups 2 are situated on the lower surface 31 of the body 1 and this body 1 contains several vacuum generators in the form of cartridges which directly supply the various suction cups 2 and, for preference, each cartridge supplies just one suction cup 2.

Thus, in FIG. 4, the body is depicted with four suction cups 2 which are connected, as detailed further on, to four cartridges. These cartridges are supplied with compressed air by means of a single pipe 26 which runs near the rear face 32 of the body 1.

The cartridges are identical to those depicted in FIG. 2; they are housed in blind bores, detailed later on, which open onto the façade 33 of the body 1. These four bores are closed off at this façade 33 by four plugs 34.

The upper part of the body 1 comprises an open cavity which forms the compressed air expansion chamber 39 and at the same time acts as a silencer thanks to a foam material 10 with which its entire volume is lined. This chamber 39 is in communication with the outlet of various cartridges via the plugs 34.

The body 1 is made of composite, of thermoplastic or of resin. It consists of an assembly of strata of which there are three or four depending on the shape of the planned arrangements which will be detailed in the next figures. These strata are bonded together and, together, form the one-piece body 1.

This design using stratification to create the body 1 makes it possible to arrive at a tooling that is compact, lightweight and above all, very sober in as much as it no longer comprises any pipes or multiple couplings.

The central part of the body 1 may consist of one stratum Sc or a pair of strata Sc1 and Sc2, which comprise:
the bores which constitute the vacuum chambers 44 of the cartridges 3,
the arrangement of the compressed air supply chamber, and
the various circuits connecting these vacuum chambers 44 to, on the one hand, the suction cups 2 and, on the other hand, the expansion chamber 39. The plane containing the boundaries between the strata Sc1 and Sc2 corresponds to the plane of the axes of the bores for the cartridges 3.

The stratum Si which constitutes the lower part of the body 1 has the arrangements necessary for attaching the suction cups 2 and the continuation of the arrangements used to connect the vacuum chambers 44 to their respective suction cups 2.

The stratum Ss which constitutes the upper part of the body 1 is fashioned around the expansion chamber 39. The strata Si, Sc, Ss comprise two or three vertical orifices 40 which are aligned, which orifices 40 are positioned between the cartridges 3 and allow the body 1 to be attached to the robot arm, not depicted.

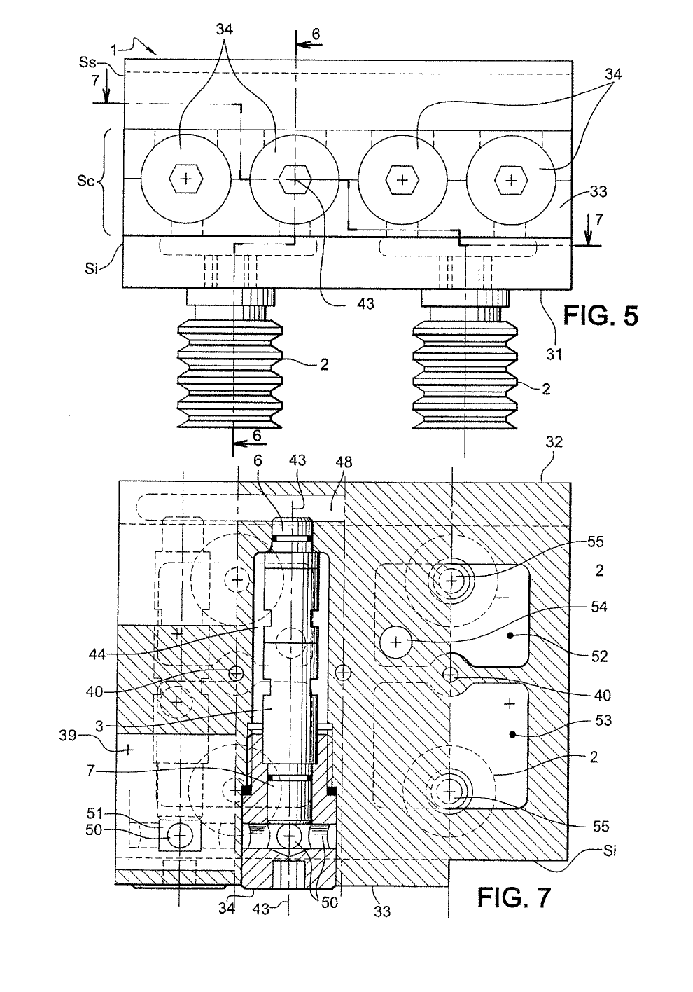

FIG. 5 shows the façade 33 of the body 1 with the plugs 34 and the suction cups 2; above all it shows sections 6-6 and 7-7 which are detailed in FIGS. 6 and 7 respectively.

FIG. 6 is a front elevation of a cross section taken through a cartridge (3) as indicated in FIG. 5. The body 1 appears in one-piece form with:
the suction cup 2 on its lower face 31,
the expansion chamber 39 on its upper part,
and, in its central part between the two: a bore which acts as a chamber 44 and in which a cartridge 3 is housed.

This bore of the chamber 44 is horizontal with respect to the suction cups 2 which are vertical, which suction cups are, for example, arranged in pairs, each pair being situated, as shown by FIG. 5 in particular, in the vertical mid-plane that runs between the two cartridges 3 that supply said suction cups 2.

The bore of the chamber 44 extends between the chamber 48 in which the compressed air arrives and the plug 34 which closes off said bore. The cartridge 3 extends, in a fluidtight manner, between the chamber 48 and the plug 34, which plug is a threaded plug which locks said cartridge into the vacuum chamber 44.

This plug 34 has bores 50 which are arranged radially at the end of the housing of the nozzle 7 of the cartridge 3. These bores 50 place the nozzle 7 of the cartridge 3 in communication with the expansion chamber 39 via an orifice 51 formed between the two of them, in the body 1.

Still referring to this FIG. 6, note the arrangements of the circuit that provides the connection between the vacuum chamber 33 of the cartridges 3 and the suction cups 2.

Within the thickness of the body 1, between the chambers 44 and the suction cups 2, there are cavities and orifices or bores. The cavities 52 and 53 visible in FIG. 6 serve respectively to supply the front and rear suction cups 2. These cavities are also visible in FIG. 7; they extend under each group of two cartridges and over the two suction cups that they supply. It is these cavities 52 and 53 that make the connection between the orifices 54 leading away from the chamber 44 and the orifices 55 that accommodate the suction cups 2 at the lower surface 31 of the body 1.

The orifices 54 are situated in the vertical mid-plane of the cartridge 3 with which they are associated while the orifices 55 are situated in the mid-plane of the suction cups 2, between the two cartridges 3 that supply these suction cups.

FIG. 7 gives an overview of the general architecture, in plan form, of the body 1 with sections made at various points.

The first section, in the left-hand part of the body 1, shows the expansion chamber 39 and the orifice 51 which places the bore 50 of the plug 34 in communication with said chamber 39.

The second section is a horizontal section through the body 1, passing through the axis 43 of the cartridge 3. This cartridge 3 extends between the compressed air inlet chamber 48 and the bores 50 arranged in the plug 34. As indicated previously, the plug 34 is screwed into the body 1 and locks the cartridge 3 in a fluidtight manner inside its bore.

The third section shows the orifice 54 which makes the connection between the corresponding vacuum chamber 44 and the cavity 52, which cavity places said orifice 54 in communication with the orifice 55 of the corresponding suction cup 2.

The fourth section, to the right in the figure, shows the cavities 52 and 53 and the orifices 55 of the two suction cups 2, which are shown in dotted line.

The orifices 40 which pass vertically through the body 1 between the cartridges 3 can also be seen in this FIG. 7, these orifices 40 allowing said body to be attached to the manipulator robot.

1-3. (canceled)

4. Tooling for holding relatively lightweight products using suction cup(s), which tooling is associated with a manipulating robot of the high-speed type, wherein it consists of a body in the form of a compact block made of an appropriate material of the thermoplastic, composite or resin type, which block is configured to combine the vacuum generators and the suction cups and for installing an ultra-short internal circuit between the two, said body comprising:
on the one hand, bores to house said vacuum generators which are in the form of cartridges, each bore constituting a vacuum chamber and extending, in a fluidtight manner, via the corresponding cartridge, between a compressed air inlet chamber and an expansion chamber which acts as a silencer on the outlet side of said cartridge, and
on the other hand, the internal circuit which connects said vacuum chamber and the corresponding suction cup, said circuit consisting of a plurality of orifices and/or cavities,
and in that said body consists of strata fashioned beforehand and then assembled and intrinsically comprising the vacuum chambers and the orifices and/or cavities which join together said chambers and said suction cups, which are grafted onto said body, and said overall supply chamber for supplying all the various cartridges and said expansion chamber which is common to said cartridges, which cartridges are arranged side by side and parallel to one another, and said suction cups are grafted under said body, perpendicular to said cartridges.

5. The tooling for holding products as claimed in claim 4, wherein the body comprises four cartridges which are housed in bores the axes of which are mutually parallel, situated in the same plane, and the suction cups are four in number also, each supplied independently of the others by one cartridge, the axes of said suction cups being perpendicular to said plane of the axes of said cartridges.

6. The tooling for holding products as claimed in claim 4, wherein it comprises, for each bore designed to accommodate the various cartridges, a shut-off member consisting of a plug which is provided with radially arranged orifices, which orifices open into the common expansion chamber, which chamber is lined with an appropriate material, of the acoustic insulation foam type, which is able to deaden the noise of the escaping compressed air leaving each cartridge.
